(19) United States
(12) Patent Application Publication
(10) Pub. No.: US 2026/0270661 A1
(43) Pub. Date: Sep. 10, 2026

(54) SYSTEM AND METHOD FOR AUTOMATIC CONFIGURATION AND PREEMPTIVE AUTHORIZATION OF MOBILE SERVICES

(71) Applicant: RealSense Al, Inc., Fort Mill, SC (US)

(72) Inventors: James M. Ingerslew, Tega Cay, SC (US); Aaron Kistler, Houston, TX (US); Alan Hartman, Louisa, VA (US)

(21) Appl. No.: 19/561,772

(22) Filed: Mar. 10, 2026

Related U.S. Application Data
(60) Provisional application No. 63/769,544, filed on Mar. 10, 2025.

(51) Int. Cl. H04W 4/38; H04W 12/037; H04W 12/08

(52) U.S. Cl. CPC H04W 4/38; H04W 12/037; H04W 12/08

(57) ABSTRACT

A system for automatically configuring a sensor mounted on mobile equipment, comprising: a plurality of radio transceivers each associated with a known location; a sensor configured to communicate with the radio transceivers; and a configuration mechanism configured to set an operational mode of the sensor based on at least one of an identifier of a connected radio transceiver, a location associated with the radio transceiver, and a type of the sensor, wherein the identifier corresponds to a location context.

### RELATED APPLICATION

This application claims the benefit of priority under 35 USC § 119(e) of U.S. Provisional Patent Application No. 63/769,544 filed on Mar. 10, 2025, the contents of which are incorporated herein by reference in their entirety.

### FIELD OF THE INVENTION

The present invention, in some embodiments thereof, relates to mobile sensing systems and, more particularly, but not exclusively, to configuration, authorization and security management of sensors operating on wireless communication networks.

### BACKGROUND OF THE INVENTION

Mobile equipment operating over large geographic areas often carries sensors that monitor operational, environmental, or mechanical conditions. Such sensors may experience substantially different operating requirements depending on their location, environment, or operational context. Conventional sensor systems are typically configured with static or manually updated parameters, which may lead to inefficient operation, excessive power consumption, or missed events when the operating context changes.

In many wireless systems, sensors communicate with radio transceivers such as gateways, base stations, or towers that are deployed at known or fixed locations. Although such network infrastructure inherently provides location-correlated information, existing systems generally fail to leverage this information to dynamically adapt sensor behavior. As a result, there exists a need for improved techniques for managing sensor configuration in mobile environments.

Conventional mobile sensing systems typically rely on configuration mechanisms driven either by manually assigned operational zones, direct position measurement subsystems such as GPS receivers, or reactive analysis of previously transmitted sensor data. Each of these approaches introduces practical limitations in mobile environments.

Manual or zone-based configuration requires external supervision and cannot adapt to unplanned routing changes or dynamically varying infrastructure coverage. Position-measurement subsystems significantly increase power consumption and hardware complexity, making them unsuitable for low-power distributed sensing deployments. Reactive configuration based on received measurements occurs only after the sensor has already operated in an unsuitable mode, resulting in delayed detection of relevant operational events and unnecessary communication overhead.

Additionally, in many wireless sensor networks, sensors are required to be authenticated or authorized by network infrastructure elements, such as gateways or access points, prior to exchanging data. Conventional authorization mechanisms are typically reactive, requiring a sensor to request authorization upon establishing communication with a network element. Such reactive approaches may introduce latency, increased signaling overhead, or delays in data transmission, particularly in mobile environments where sensors frequently transition between network access points.

Furthermore, authorization data such as cryptographic keys or other access control information is often statically provisioned or managed independently at each network element, limiting the ability of the network to efficiently support mobile sensors. Accordingly, there exists a need for improved techniques for managing authorization of mobile sensors in wireless networks.

In many existing wireless sensor networks, authorization occurs only after a mobile sensor attempts to establish communication with a network access point. In mobile environments, this reactive approach may introduce delays associated with authentication exchanges, key negotiation, or access control verification.

### SUMMARY OF THE INVENTION

According to an aspect of some embodiments of the present invention, there is provided a system for automatically configuring a sensor mounted on mobile equipment. The system comprises a plurality of radio transceivers, each associated with a known location, a sensor configured to communicate with the radio transceivers, and a configuration mechanism configured to set an operational mode of the sensor based on at least one of an identifier of a connected radio transceiver, a location associated with the radio transceiver, and a type of the sensor.

In some embodiments, the operational mode includes selection of a communication interface associated with the operational context.

According to an aspect of some embodiments of the present invention, there is provided a method for automatically configuring a sensor mounted on mobile equipment. The method comprises connecting the sensor to a radio transceiver, obtaining a location context based on the radio transceiver, and setting an operational mode of the sensor based on the location context and a sensor type.

According to some embodiments of the invention, the configuration mechanism is implemented by a remote server that transmits configuration commands to the sensor.

According to other embodiments, the configuration mechanism is embedded within the sensor itself. According to further embodiments, the configuration mechanism preemptively sets an operational mode based on an anticipated future location of the sensor.

According to an aspect of some embodiments of the present invention, there is provided a system for automatically configuring a sensor mounted on mobile equipment, comprising: a plurality of radio transceivers each associated with a known location; a sensor configured to communicate with the radio transceivers; and a configuration mechanism configured to set an operational mode of the sensor based on at least one of an identifier of a connected radio transceiver, a location associated with the radio transceiver, and a type of the sensor, wherein the identifier corresponds to a location context.

In an embodiment of the invention, the configuration mechanism comprises a server configured to transmit configuration commands to the sensor.

In an embodiment of the invention, the configuration mechanism is embedded within the sensor.

In an embodiment of the invention, the operational mode affects at least one of triggering events, data sampling behavior, data storage behavior, or wireless communication behavior.

In an embodiment of the invention, the configuration mechanism is further configured to set the operational mode based on an inferred direction of travel of the mobile equipment.

In an embodiment of the invention, the configuration mechanism preemptively sets the operational mode of the sensor prior to the sensor establishing communication with a subsequent radio transceiver.

In an embodiment of the invention, the location context is determined using an identifier transmitted by the radio transceiver and without obtaining geographic coordinates of the sensor.

In an embodiment of the invention, the configuration mechanism determines the operational mode using a stored mapping between radio transceiver identifiers and operational modes.

In an embodiment of the invention, setting the operational mode comprises transmitting configuration data to the sensor upon establishing communication with the radio transceiver.

In an embodiment of the invention, the operational mode changes a sampling interval of the sensor.

In an embodiment of the invention, the configuration mechanism determines the subsequent radio transceiver based on a sequence of previously connected radio transceivers.

In an embodiment of the invention, the operational mode further comprises selecting one of a plurality of available wireless communication interfaces based on the determined or anticipated location context.

According to an aspect of some embodiments of the present invention, there is provided a method for automatically configuring a sensor mounted on mobile equipment, comprising: connecting the sensor to a radio transceiver; obtaining a location context based on the radio transceiver; and setting an operational mode of the sensor based on the location context and a sensor type.

In an embodiment of the invention, the method further comprises anticipating a subsequent location context of the sensor, and preemptively setting the operational mode based on the anticipated subsequent location context.

In an embodiment of the invention, the method further comprises selecting a wireless communication network for transmitting sensor data based on the location context.

According to an aspect of some embodiments of the present invention, there is provided a system for automatically authorizing a mobile sensor in a wireless network. The system comprises a plurality of network access points, each configured to communicate with mobile sensors, and a central authorization mechanism configured to manage authorization data associated with the mobile sensors.

The authorization mechanism is configured to anticipate a future network access point with which a mobile sensor is expected to communicate and to distribute authorization data to the anticipated network access point prior to the mobile sensor establishing communication therewith. Upon the mobile sensor establishing communication with the anticipated network access point, the sensor may be authorized with reduced latency.

According to an aspect of some embodiments of the present invention, there is provided a method for automatically authorizing a mobile sensor, comprising anticipating a future network access point with which the sensor is expected to communicate, distributing authorization data associated with the sensor to the anticipated network access point, and authorizing the sensor upon connection to the anticipated network access point.

According to an aspect of some embodiments of the invention, there is provided a system for automatically authorizing a mobile sensor in a wireless network, comprising: a plurality of network access points; a mobile sensor configured to communicate with the network access points; and an authorization mechanism configured to anticipate a future network access point with which the mobile sensor is expected to communicate and to distribute authorization data associated with the mobile sensor to the anticipated network access point prior to the mobile sensor establishing communication therewith.

In an embodiment of the invention, the authorization mechanism comprises a server configured to manage authorization data for a plurality of mobile sensors.

In an embodiment of the invention, the authorization data comprises at least one of cryptographic keys or access control information.

In an embodiment of the invention, the authorization data is distributed to the anticipated network access point prior to the mobile sensor entering a coverage area associated with the anticipated network access point.

In an embodiment of the invention, the authorization mechanism determines the anticipated network access point based on a sequence of previously connected network access points.

In an embodiment of the invention, the authorization data comprises cryptographic credentials distributed to the anticipated network access point prior to the mobile sensor entering a communication coverage area associated with the anticipated network access point.

In an embodiment of the invention, the anticipated network access point applies the distributed authorization data to authorize the mobile sensor without performing a full authentication exchange.

According to a further aspect of some embodiments of the invention, there is provided method for automatically authorizing a mobile sensor in a wireless network, comprising: anticipating a future network access point with which the mobile sensor is expected to communicate; distributing authorization data associated with the mobile sensor to the anticipated network access point; and authorizing the mobile sensor upon connection to the anticipated network access point.

In an embodiment of the invention, the authorization data is distributed to the anticipated network access point prior to the mobile sensor entering a coverage area associated with the anticipated network access point.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting. Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example, are not necessarily to scale and are for purposes of illustrative discussion of embodiments of the invention. In this regard, the description taken with the drawings makes apparent to those skilled in the art how embodiments of the invention may be practiced.

In the drawings:

FIG. 1 is an illustration of a mobile sensor communicating with multiple radio transceivers at known locations, in accordance with an exemplary embodiment of the invention;

FIG. 2 is an illustration of a system architecture including a server-based configuration mechanism, in accordance with an exemplary embodiment of the invention;

FIG. 3 is an illustration of a sensor with an embedded configuration mechanism, in accordance with an exemplary embodiment of the invention;

FIG. 4 is a flowchart of automatic sensor configuration based on a connected radio transceiver, in accordance with an exemplary embodiment of the invention;

FIG. 5 is a flowchart including preemptive configuration based on an anticipated future location, in accordance with an exemplary embodiment of the invention;

FIG. 6 illustrates an example server-based authorization architecture for automatically authorizing a mobile sensor, in accordance with an exemplary embodiment of the invention;

FIG. 7 illustrates an example method flow for preemptively distributing authorization data to support reduced-latency authorization of a mobile sensor, in accordance with an exemplary embodiment of the invention; and,

FIG. 8 illustrates an example outcome enabled by preemptive authorization of a mobile sensor, in accordance with an exemplary embodiment of the invention.

### DESCRIPTION OF SPECIFIC EMBODIMENTS OF THE INVENTION

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### Automatic Configuration

The present invention uses connectivity with known network infrastructure as a deterministic operational context input rather than as a transport mechanism alone. Because network attachment inherently occurs prior to meaningful data exchange, configuration can be determined at or prior to the moment communication capability becomes available instead of after condition detection or external instruction.

By deriving operational context from communication topology rather than explicit positioning, the system enables context-appropriate sensor behavior without requiring continuous high-power location tracking or centralized supervision. This architecture allows configuration changes to occur predictively in association with changes in communication infrastructure, reducing latency in applying relevant sensing parameters, decreasing unnecessary transmissions, and improving detection reliability in changing operational environments.

The present invention, in some embodiments thereof, relates to automatic configuration of sensors mounted on mobile equipment. As used herein, the term “operational mode” refers to one or more parameters that govern sensor behavior, including but not limited to triggering conditions, data sampling rates, data storage behavior, and wireless transmission or reception behavior.

In one embodiment, a sensor mounted on mobile equipment establishes a wireless connection with a radio transceiver deployed at a known location. The radio transceiver provides an identifier that is associated with the known location. A configuration mechanism selects or determines an operational mode of the sensor based on the identifier and a sensor type.

In some embodiments, the configuration mechanism is implemented by a server that maintains a mapping between radio transceiver identifiers, sensor types, and operational modes. Upon connection, the server transmits a configuration command to the sensor.

In other embodiments, the configuration mechanism is embedded within the sensor. The sensor stores a mapping table and autonomously selects an operational mode upon connection to a radio transceiver.

In further embodiments, the configuration mechanism anticipates a future location of the sensor based on historical movement or known routes and preemptively configures the sensor for a subsequent operational mode prior to establishing a connection with a next radio transceiver.

In some embodiments, the operational mode further includes selecting among multiple available wireless communication interfaces. The sensor may include more than one communication interface, and the configuration mechanism may select a communication interface based on the determined or anticipated location context. Selection of the communication interface may optimize power consumption, communication range, latency, or network availability.

### Exemplary Hardware and Functional Components

### Sensor

The sensor described herein may comprise one or more processors or microcontrollers, signal conditioning circuitry, memory elements, and one or more wireless communication interfaces. In some embodiments, the sensor may include low-power embedded processors (for example ARM-based microcontrollers), flash or other non-volatile memory for storing configuration data and executable instructions, and wireless communication interfaces supporting technologies such as LoRaWAN, cellular, Wi-Fi, Bluetooth, or other low-power wide-area communication systems. The sensor may further include sensing elements configured to detect vibration, temperature, motion, load, acoustic signals, or other environmental or operational parameters depending on the application. Configuration data, mapping tables, and executable instructions stored in memory may control operational mode selection and sensor behavior.

The sensor is configured to modify its operational behavior in response to configuration data, including adjusting triggering conditions, sampling rates, data buffering behavior, transmission frequency, or communication parameters.

The sensor may operate intermittently or continuously and may enter low-power states between communication events.

### Radio Transceiver

Each radio transceiver may comprise a wireless communication interface deployed at a known location and configured to communicate with one or more mobile sensors. The radio transceiver may include a processor, memory, and communication circuitry capable of broadcasting or transmitting an identifier associated with its deployment location.

In some embodiments, the radio transceiver may comprise a gateway or access point compatible with communication technologies such as LoRaWAN, cellular networks, Wi-Fi infrastructure, Bluetooth infrastructure, or other wireless communication systems.

The radio transceiver may function as a gateway, base station, access point, relay node, or other infrastructure component that provides connectivity between the sensor and a wider communication network. In some embodiments, the radio transceiver may also relay configuration data between a remote server and the sensor.

### Configuration Mechanism

The configuration mechanism may comprise hardware, software, firmware, or a combination thereof configured to determine an operational mode of a sensor based on location context and sensor type. The configuration mechanism may execute mapping logic, rule-based evaluation, table lookup, or other decision processes that associate location contexts with operational modes.

In some embodiments, the configuration mechanism is implemented within the sensor. In other embodiments, the configuration mechanism is implemented within a remote computing system, such as a configuration server, or distributed between multiple computing components.

### Configuration Server

Where implemented as a remote component, the configuration server may comprise one or more computing devices including processors, memory, network interfaces, and storage systems configured to maintain mappings between radio transceiver identifiers, sensor types, and operational modes. The configuration server may communicate with radio transceivers and sensors via wired or wireless communication networks.

The configuration server may be implemented using conventional computing infrastructure such as cloud computing platforms, edge servers, or industrial control systems.

The configuration server may generate configuration commands, transmit configuration data, log operational transitions, and update mapping tables based on system policies or external inputs.

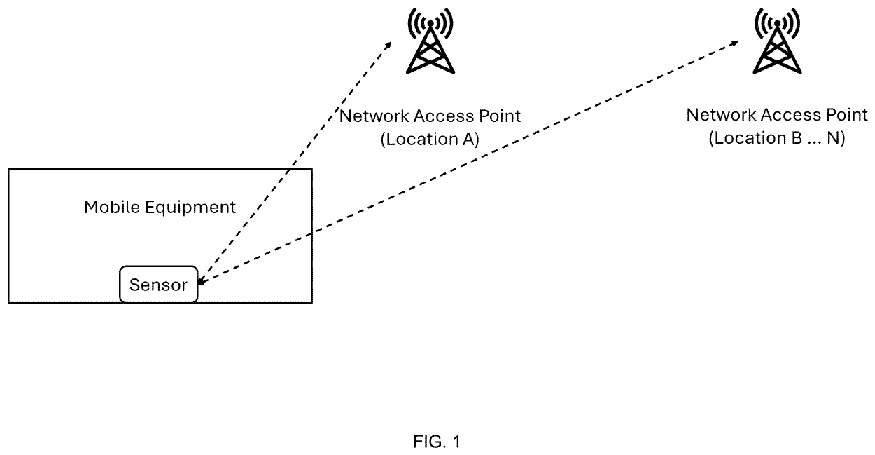

Referring now to the drawings, FIG. 1 illustrates a system overview of an automatic configuration system according to some embodiments of the present invention. The system includes a sensor mounted on mobile equipment and configured to communicate with one or more radio transceivers located at known locations.

In the illustrated embodiment, the sensor establishes wireless communication with a first radio transceiver associated with a first location and subsequently with a second radio transceiver associated with a different location. Each radio transceiver provides an identifier that is associated with a known location context.

As the mobile equipment moves between locations, the sensor may communicate with different radio transceivers, thereby enabling the system to detect changes in location context without requiring direct position measurement. This arrangement allows sensor operation to be adapted based on location-dependent requirements.

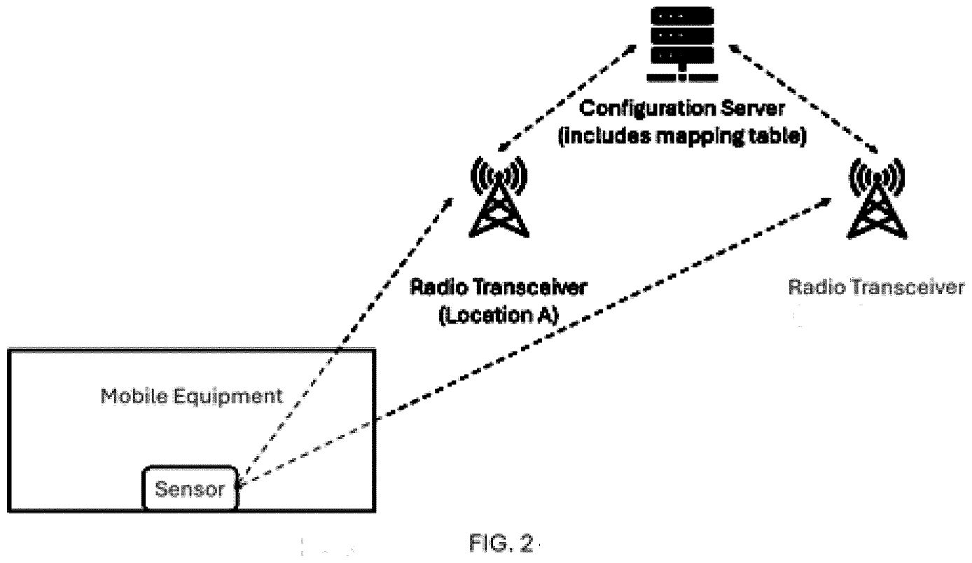

FIG. 2 is a server-based configuration architecture illustrating some embodiments of the present invention. In this embodiment, a configuration server is communicatively coupled to one or more radio transceivers and maintains configuration data associated with combinations of sensor types and location contexts.

Upon a sensor establishing communication with a radio transceiver, the configuration server determines an appropriate operational mode for the sensor based on the identifier of the connected radio transceiver and optionally the sensor type. The configuration server may then transmit a configuration command to the sensor via the radio transceiver.

This embodiment enables centralized management of sensor configuration while allowing sensors to dynamically adapt their operation as they traverse different locations.

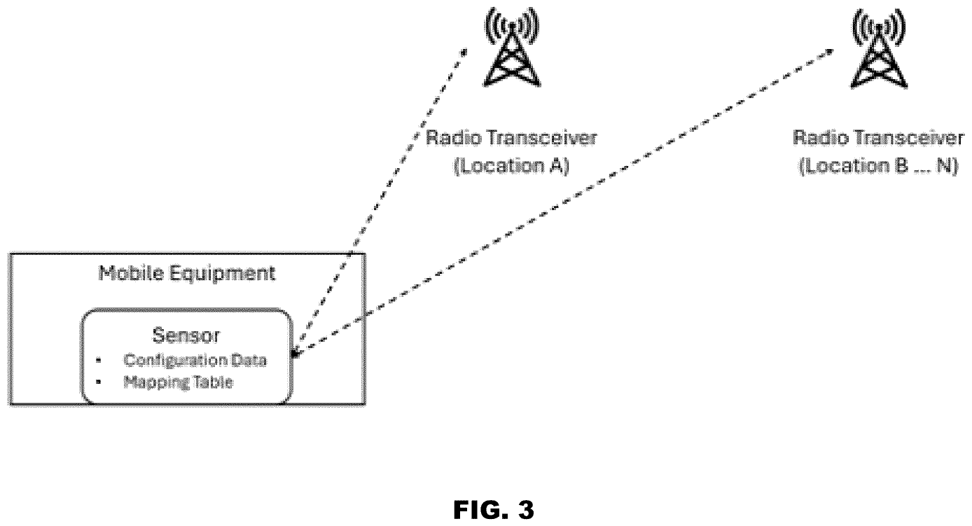

FIG. 3 is a sensor-embedded configuration architecture illustrating some embodiments of the present invention. In this embodiment, configuration logic and configuration data are embedded within the sensor itself.

The sensor autonomously determines an operational mode based on a location context derived from a connected radio transceiver, without reliance on a remote configuration server. The sensor may store configuration data locally and apply configuration changes upon detecting a change in location context.

This embodiment enables autonomous operation of the sensor and may reduce communication latency and dependency on network infrastructure.

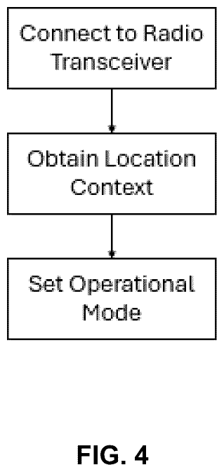

FIG. 4 is a reactive configuration method illustrating some embodiments of the present invention.

The method includes establishing communication between a sensor and a radio transceiver, receiving an identifier associated with the radio transceiver, and resolving a location context corresponding to the identifier. A configuration mechanism evaluates the location context together with a sensor type and determines an operational mode associated with the resolved context.

The configuration mechanism generates configuration data corresponding to the determined operational mode and applies the configuration data to the sensor. Applying the configuration data may include transmitting a configuration command to the sensor, updating locally stored configuration parameters, or activating predefined operational behavior associated with the operational mode.

Optionally, the system may confirm that the operational mode has been applied and continues monitoring for subsequent changes in location context to repeat the method when a different radio transceiver is detected.

The steps illustrated in FIG. 4 may be performed by a remote server, by the sensor itself, or by a combination thereof, thereby enabling the sensor to adapt its operation in response to a detected change in location context.

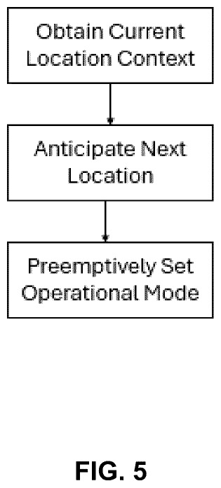

FIG. 5 illustrates a preemptive configuration method according to some embodiments of the present invention.

The method includes determining a current location context associated with a sensor and predicting a subsequent location context based on historical movement information, known routes, connectivity sequences, timing patterns, or other available contextual information.

A configuration mechanism determines an operational mode associated with the anticipated location context prior to communication with a corresponding radio transceiver. Configuration data corresponding to the anticipated operational mode is prepared in advance and stored at the sensor, at a remote server, at a radio transceiver, or at a combination thereof.

Upon the sensor subsequently establishing communication with the radio transceiver associated with the anticipated location context, the prepared configuration data is applied without requiring a full re-determination of the operational mode. This reduces delay between connectivity and context-appropriate operation and enables the sensor to operate in the appropriate mode upon or immediately after communication establishment.

### EXAMPLES

The following example scenarios illustrate representative implementations of the systems and methods described herein and are consistent with the architectures and processes shown in FIGS. 1-5. These examples are provided solely to demonstrate practical application of the disclosed concepts and are not intended to limit the scope of the invention.

### Example 1—Rail Vehicle Monitoring

In one example embodiment, a vibration sensor is mounted on a rail vehicle configured to traverse multiple facilities including rail yards, loading terminals, and mainline track segments. Each facility includes radio transceivers deployed at known locations.

When the sensor establishes communication with a radio transceiver associated with a rail yard, the configuration mechanism selects an operational mode that increases sampling frequency and enables event-triggered transmission to detect loading or handling activity. The operational mode may also permit acceptance of configuration or firmware updates while the sensor is within the rail yard communication environment.

Firmware and configuration data may be significantly larger than normal sensor data transmissions, and the rail yard communication infrastructure provides extended communication availability. Accordingly, the configuration mechanism may enable higher-bandwidth reception behavior in this context while maintaining low-power transmission behavior during transit operation.

This configuration change occurs automatically based on the identity of the connected radio transceiver without requiring direct geographic positioning or manual reconfiguration.

### Example 2—Industrial Equipment Monitoring

In another embodiment, a sensor is mounted on mobile industrial equipment operating within multiple operational zones of a facility. Radio transceivers deployed in different zones provide identifiers corresponding to distinct operational contexts.

Upon detecting communication with a radio transceiver in a high-risk operational zone, the configuration mechanism increases sensitivity thresholds and reduces transmission intervals to prioritize rapid event detection. When the equipment transitions to a low-activity zone, the sensor automatically reduces sampling rate and enters a lower power operational mode.

This example demonstrates how network-derived location context enables adaptive behavior while reducing power consumption and communication overhead.

### Example 3—Communication Network Selection

In another embodiment, the sensor includes multiple wireless communication interfaces. When operating in a wide-area transit environment, the configuration mechanism selects a communication interface optimized for long-range low-power communication. When operating in an environment with local infrastructure coverage, the configuration mechanism selects a short-range communication network. The selection occurs automatically based on the location context derived from communication with infrastructure associated with the operational environment.

### Example 4—Fleet Vehicle Monitoring

In another embodiment, sensors are mounted on fleet vehicles that travel between distribution centers and highway routes. Radio transceivers deployed at logistics facilities provide location context identifiers. When a vehicle enters a distribution center environment, the configuration mechanism may increase sensing activity and transmission frequency to monitor loading operations. When the vehicle returns to highway transit, the configuration mechanism may reduce sampling frequency and transmission activity to conserve power while maintaining periodic status monitoring.

### Example 5—Port and Container Monitoring

In another embodiment, sensors are attached to shipping containers or port handling equipment. Radio transceivers deployed in port terminals and storage yards provide location context information. When a container enters a terminal handling zone, the configuration mechanism may enable higher sampling rates and event-triggered transmission to monitor loading and unloading activity. When the container leaves the port environment and enters long-distance transit, the configuration mechanism may reduce communication frequency and enter a low-power monitoring mode.

### Automatic Preemptive Authorization

The present invention, in some embodiments thereof, relates to automatic authorization of mobile sensors in wireless networks. As used herein, the term “authorization data” may include cryptographic keys, access control information, credentials, or other data required to permit a sensor to communicate with a network access point.

The present invention anticipates future connectivity events and distributes authorization data in advance based on predicted communication topology. Because authorization data is already available at the network access point when the sensor arrives, communication can begin immediately upon connection rather than after a reactive authorization exchange. This architecture reduces signaling overhead, decreases connection latency, and improves reliability of data transmission in environments where sensors frequently transition between network access points.

In one embodiment, a mobile sensor communicates with a plurality of network access points as it moves through a geographic area. A central authorization mechanism maintains authorization data for the mobile sensor and is configured to distribute such data to one or more network access points.

In some embodiments, the authorization mechanism anticipates a future network access point based on historical movement of the mobile sensor, known routes, or other available information. Authorization data is transmitted to the anticipated network access point prior to the mobile sensor establishing communication therewith.

In this manner, when the mobile sensor subsequently connects to the anticipated network access point, authorization may be performed immediately upon connection with reduced latency, enabling timely data transmission and improved network efficiency.

### Example Hardware and Functional Components

### Mobile Sensor

The sensor described herein may comprise one or more processors or microcontrollers, signal conditioning circuitry, memory elements, and one or more wireless communication interfaces. In some embodiments, the sensor may include low-power embedded processors (for example ARM-based microcontrollers), flash or other non-volatile memory for storing configuration data and executable instructions, and wireless communication interfaces supporting technologies such as LoRaWAN, cellular, Wi-Fi, Bluetooth, or other low-power wide-area communication systems. The sensor may further include sensing elements configured to detect vibration, temperature, motion, load, acoustic signals, or other environmental or operational parameters depending on the application. Configuration data, mapping tables, and executable instructions stored in memory may control authorization behavior and communication behavior of the sensor.

The sensor may store device identifiers, cryptographic credentials, or security tokens used during authorization procedures with network infrastructure elements.

### Network Access Point

Each network access point may comprise a wireless communication gateway, base station, or access point capable of communicating with one or more mobile sensors. In some embodiments, the network access point may be implemented as a LoRaWAN gateway, cellular base station, Wi-Fi access point, edge computing node, or other infrastructure device capable of receiving and applying authorization data.

The network access point may store authorization credentials or access control information received from the authorization mechanism and apply such information when a mobile sensor establishes communication.

### Authorization Mechanism/Server

The authorization mechanism may comprise one or more computing devices configured to manage authorization data associated with mobile sensors. The authorization mechanism may be implemented as a centralized authorization server, cloud-based computing service, edge computing platform, or distributed computing system.

The authorization mechanism may maintain databases of authorization credentials, cryptographic keys, or access control information and may distribute such data to network access points in anticipation of future communication events.

Referring now to the drawings, FIG. 1 illustrates an example system environment in which a sensor mounted on mobile equipment communicates with a plurality of network access points as the mobile equipment moves through different locations.

The system includes mobile equipment carrying a sensor, where the sensor is configured to establish wireless communication with one or more network access points, such as a network access point associated with a first location (Location A) and additional network access points associated with other locations (Locations B . . . N). Each network access point may be associated with a known or determinable location context.

The illustrated configuration is exemplary only, and in other embodiments the system may include additional sensors, additional mobile equipment, or additional network access points.

As the mobile equipment moves between locations, the sensor may communicate with different network access points, enabling the system to support mobile operation across a distributed network infrastructure.

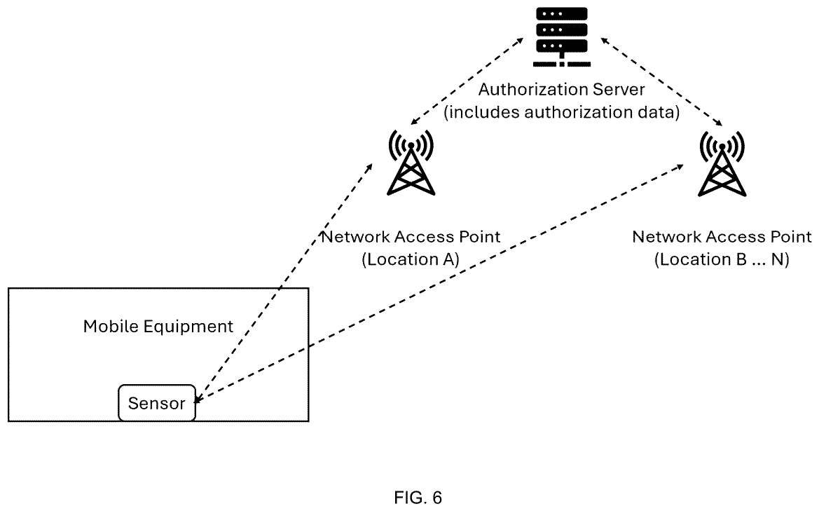

FIG. 6 illustrates an example server-based authorization architecture for automatically authorizing a mobile sensor.

In the illustrated embodiment, an authorization server maintains or manages authorization data associated with one or more sensors. The authorization server is configured to communicate with a plurality of network access points, which in turn communicate wirelessly with the sensor mounted on the mobile equipment.

The authorization server may preemptively distribute authorization data to one or more network access points, including network access points that the sensor has not yet contacted. The network access points may store or apply the authorization data to facilitate subsequent communication with the sensor.

In this manner, authorization decisions and data management may be centralized, while authorization enforcement is performed at distributed network access points.

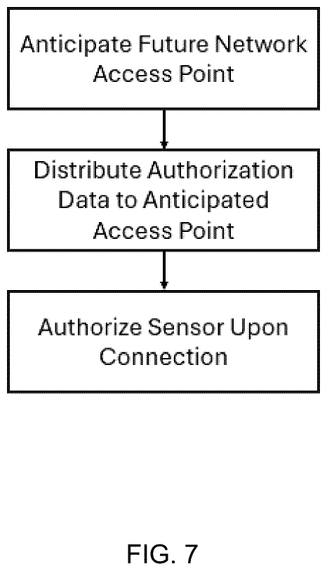

FIG. 7 illustrates an example method flow for preemptively distributing authorization data to support reduced-latency authorization of a mobile sensor.

In one aspect, a future network access point with which the sensor is expected to communicate is anticipated, based on available information such as prior connectivity, movement patterns, or other contextual data. Authorization data associated with the sensor is then distributed to the anticipated network access point prior to the sensor establishing communication therewith.

When the sensor subsequently establishes communication with the anticipated network access point, the sensor may be authorized using the previously distributed authorization data.

By distributing authorization data in advance, the system reduces or eliminates delays associated with reactive authorization procedures.

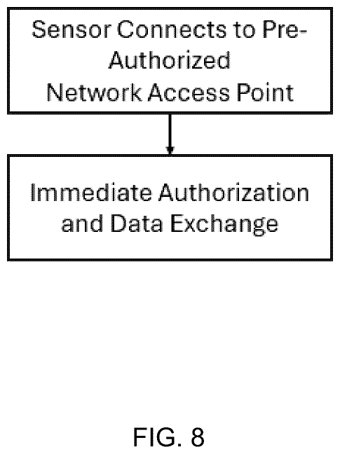

FIG. 8 illustrates an example outcome enabled by preemptive authorization of a mobile sensor.

In the illustrated embodiment, the sensor establishes communication with a pre-authorized network access point. Because authorization data has already been distributed to the network access point, authorization and data exchange may occur immediately upon establishing communication.

This reduced-latency authorization enables faster data transmission, improved responsiveness, and more efficient operation of mobile sensors, particularly in environments where sensors frequently transition between network access points.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

### EXAMPLE USE CASE SCENARIOS

The following example scenarios illustrate representative implementations of the systems and methods described herein and are consistent with the architectures shown in FIGS. 1 and 6-8. These examples are provided solely to demonstrate practical application of the disclosed concepts and are not intended to limit the scope of the invention.

### Example 1—Mobile Sensor Transit Between Network Gateways

In one embodiment, a sensor mounted on mobile equipment travels through an environment containing multiple network gateways. Based on prior connectivity patterns or known routes, the authorization mechanism predicts the next gateway that the sensor will contact. Authorization credentials associated with the sensor are distributed to the predicted gateway in advance. When the sensor subsequently establishes communication with the gateway, authorization occurs immediately without requiring a full authentication exchange.

### Example 2—Industrial Mobile Equipment

In another embodiment, sensors mounted on mobile industrial equipment move between operational zones within a facility. Network access points deployed in different zones provide wireless connectivity. The authorization mechanism anticipates the next network access point that the equipment will encounter and distributes authorization data in advance. When the equipment enters the new zone, the sensor is immediately authorized and able to transmit data without delay.

### Example 3—Transportation Infrastructure

In another embodiment, sensors mounted on transportation assets move between infrastructure elements such as rail yards, terminals, or logistics facilities. Network access points deployed at these facilities provide communication coverage. The authorization mechanism anticipates the next infrastructure location and distributes authorization credentials to the corresponding network access point prior to the sensor arriving, enabling immediate communication upon connection.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The term “plurality” means “two or more”.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A system for automatically configuring a sensor mounted on mobile equipment, comprising:
a plurality of radio transceivers each associated with a known location;
a sensor configured to communicate with the radio transceivers; and
a configuration mechanism configured to set an operational mode of the sensor based on at least one of an identifier of a connected radio transceiver, a location associated with the radio transceiver, and a type of the sensor, wherein the identifier corresponds to a location context.

2. The system of claim 1, wherein the configuration mechanism comprises a server configured to transmit configuration commands to the sensor.

3. The system of claim 1, wherein the configuration mechanism is embedded within the sensor.

4. The system of claim 1, wherein the operational mode affects at least one of triggering events, data sampling behavior, data storage behavior, or wireless communication behavior.

5. The system of claim 1, wherein the configuration mechanism is further configured to set the operational mode based on an inferred direction of travel of the mobile equipment.

6. The system of claim 1, wherein the configuration mechanism preemptively sets the operational mode of the sensor prior to the sensor establishing communication with a subsequent radio transceiver.

7. The system of claim 1, wherein the location context is determined using an identifier transmitted by the radio transceiver and without obtaining geographic coordinates of the sensor.

8. The system of claim 1, wherein the configuration mechanism determines the operational mode using a stored mapping between radio transceiver identifiers and operational modes.

9. The system of claim 1, wherein setting the operational mode comprises transmitting configuration data to the sensor upon establishing communication with the radio transceiver.

10. The system of claim 1, wherein the operational mode changes a sampling interval of the sensor.

11. The system of claim 6, wherein the configuration mechanism determines the subsequent radio transceiver based on a sequence of previously connected radio transceivers.

12. The system of claim 1, wherein the operational mode further comprises selecting one of a plurality of available wireless communication interfaces based on the determined or anticipated location context.

13. A method for automatically configuring a sensor mounted on mobile equipment, comprising:
connecting the sensor to a radio transceiver;
obtaining a location context based on the radio transceiver; and
setting an operational mode of the sensor based on the location context and a sensor type.

14. The method of claim 13, further comprising anticipating a subsequent location context of the sensor, and preemptively setting the operational mode based on the anticipated subsequent location context.

15. The method of claim 13, further comprising selecting a wireless communication network for transmitting sensor data based on the location context.

16. A system for automatically authorizing a mobile sensor in a wireless network, comprising:
a plurality of network access points;
a mobile sensor configured to communicate with the network access points; and
an authorization mechanism configured to anticipate a future network access point with which the mobile sensor is expected to communicate and to distribute authorization data associated with the mobile sensor to the anticipated network access point prior to the mobile sensor establishing communication therewith.

17. The system of claim 1, wherein the authorization mechanism comprises a server configured to manage authorization data for a plurality of mobile sensors.

18. The system of claim 1, wherein the authorization data comprises at least one of cryptographic keys or access control information.

19. The system of claim 1, wherein the authorization data is distributed to the anticipated network access point prior to the mobile sensor entering a coverage area associated with the anticipated network access point.

20. The system of claim 1, wherein the authorization mechanism determines the anticipated network access point based on a sequence of previously connected network access points.

21. The system of claim 1, wherein the authorization data comprises cryptographic credentials distributed to the anticipated network access point prior to the mobile sensor entering a communication coverage area associated with the anticipated network access point.

22. The system of claim 1, wherein the anticipated network access point applies the distributed authorization data to authorize the mobile sensor without performing a full authentication exchange.

23. A method for automatically authorizing a mobile sensor in a wireless network, comprising:
anticipating a future network access point with which the mobile sensor is expected to communicate;
distributing authorization data associated with the mobile sensor to the anticipated network access point; and
authorizing the mobile sensor upon connection to the anticipated network access point.

24. The method of claim 23, wherein the authorization data is distributed to the anticipated network access point prior to the mobile sensor entering a coverage area associated with the anticipated network access point.
